(19) United States
(12) Patent Application Publication
(10) Pub. No.: US 2026/0244757 A1
(43) Pub. Date: Aug. 20, 2026

(54) MODEL-BASED VALIDATION OF REPORTED SOFTWARE VULNERABILITIES

(71) Applicant: SAP SE, Walldorf (DE)

(72) Inventors: Dilip Mamidela, Bangalore (IN); Victor Chung, Vancouver (CA)

(73) Assignee: SAP SE, Walldorf (DE)

(21) Appl. No.: 19/058,601

(22) Filed: Feb. 20, 2025

(51) Int. Cl. G06F 21/57

(52) U.S. Cl. CPC G06F 21/577; G06F 2221/033

(57) ABSTRACT

A computer-implemented method can receive a submitted vulnerability specifying a vulnerability type and steps to reproduce a suspected bug of a software, determine a first base model score based on keywords appeared in the vulnerability form, determine a second base model score based on vulnerability type-specific contextual information extracted from the vulnerability form, determine a first probability modifier based on features identified from the vulnerability form, determine a second probability modifier based on mapping any file attachment associated with the vulnerability form to a corresponding step, determine a third probability modifier based on pairing and grouping selected steps, determine a vulnerability score based on the first and second base model scores, and the first, second, and third probability modifiers, and classify the vulnerability form as valid or invalid based on the vulnerability score. Related systems and software for implementing the method are also disclosed.

### BACKGROUND

Development of software, including enterprise software and open-source software, has driven advancements in transparency, innovation, and community collaboration, offering substantial benefits to the software industry. However, it also introduces challenges, notably the increasing discovery and disclosure of vulnerabilities within the software. Software vulnerabilities are security weaknesses that, if exploited, can compromise systems and data. Conventionally, software vulnerabilities can be reported by security researchers and/or users of the software through vulnerability disclosure programs by submitting vulnerability forms. These forms typically contain details such as affected software components, steps to reproduce the issue, and potential security impacts. However, not all submitted vulnerabilities are valid, and distinguishing between genuine security threats and false positives remains a significant challenge. Traditional assessment methods often require extensive manual effort, leading to inefficiencies and resource strain. Accordingly, there is a need for improved techniques that enhance the accuracy and efficiency of validating vulnerability forms, ensuring that security teams can focus on addressing real threats while minimizing time spent on invalid vulnerability reports.

### BRIEF DESCRIPTION OF THE DRAWINGS

FIG. 1 is a block diagram depicting an example computing system for automated software vulnerability validation.

FIG. 2 is a block diagram depicting an example workflow for runtime automated software vulnerability validation.

FIG. 3 depicts an example submitted vulnerability form.

FIG. 4 depicts an example attachment associated with the vulnerability form of FIG. 3.

FIG. 5 depicts another example submitted vulnerability form.

FIG. 6 is a flowchart illustrating an example overall method for automated software vulnerability validation.

FIG. 7 schematically depicts examples of step pairing and grouping.

FIG. 8 is a block diagram of an example computing system in which described embodiments can be implemented.

FIG. 9 is a block diagram of an example cloud computing environment that can be used in conjunction with the technologies described herein.

### DETAILED DESCRIPTION

### Overview of Software Vulnerability Assessment

Detecting software vulnerabilities is a critical component of maintaining secure, stable, and reliable systems in today's interconnected digital landscape. Vulnerabilities encompass not only security weaknesses or flaws that can expose systems to unauthorized access or malicious exploitation but also other defects, such as software bugs, that can lead to crashes, degraded performance, or other undesirable behaviors. These issues can disrupt business operations, compromise user experience, and undermine trust in software systems. As software ecosystems grow more complex, the timely identification and mitigation of such vulnerabilities are essential to ensuring operational continuity and data integrity.

Traditionally, vulnerability assessment has relied on manual reviews of submitted vulnerability forms (also referred to as vulnerability reports) conducted by security teams. For examples, security researchers or users can submit vulnerability forms that document suspected flaws in a software, providing details such as the affected software component, vulnerability type, reproduction steps, and potential security risks. However, this manual review process introduces inefficiencies due to the sheer volume of reported vulnerabilities, many of which turn out to be false positives. Security teams must sift through these vulnerability forms, validating each submission to determine whether it constitutes a genuine threat. This process is not only time-consuming but also prone to human error, leading to situations where false positives consume valuable resources or, conversely, legitimate vulnerabilities are overlooked.

The increasing complexity of modern software architectures further compounds this challenge. Vulnerabilities often arise due to intricate interactions between software components, configuration settings, and runtime environments. Simple rule-based or keyword-matching approaches to vulnerability validation are insufficient in this dynamic landscape, as they fail to capture nuanced patterns that distinguish valid security threats from irrelevant or low-impact issues. Moreover, traditional scanning tools often lack the contextual awareness needed to evaluate vulnerabilities holistically, leading to misclassifications that demand further manual validation. As organizations scale their software development efforts, there is a pressing need for an intelligent, automated solution that enhances the accuracy and efficiency of vulnerability assessment.

The technologies described herein address many of the above challenges by implementing an ingenious model for automated software vulnerability assessment that systematically analyzes vulnerability forms based on structured evaluation criteria. The model assigns scores to reported vulnerabilities by identifying relevant keywords, assessing contextual risk, analyzing attachments for supporting evidence, and examining the logical consistency of reported reproduction steps. Through a multi-stage validation process, the model can effectively distinguish between valid and invalid vulnerability submissions. This structured approach reduces manual effort, enhances the reliability of vulnerability validation, and ensures that security teams can efficiently allocate resources toward addressing genuine security threats.

### Example Computing System for Automated Software Vulnerability Validation

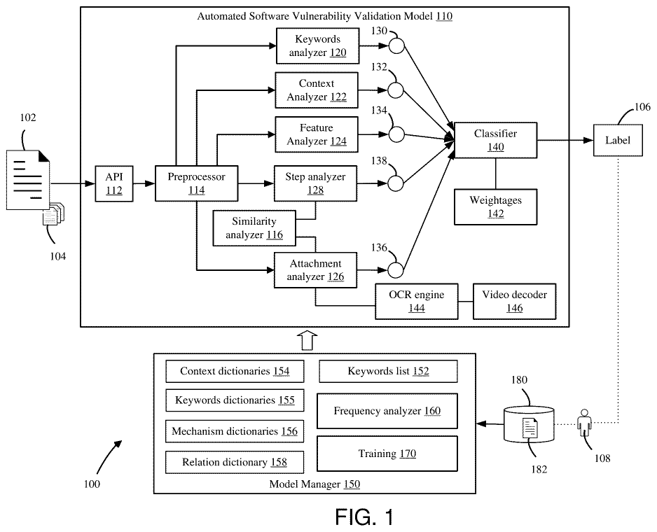

FIG. 1 depicts an example computing system 100 for automated software vulnerability validation, according to the technologies disclosed herein.

The computing system 100 is configured to process a vulnerability form 102 submitted for a software, optionally accompanied by one or more file attachments 104, and classify the submission as valid or invalid based on a structured evaluation process. Processing of the vulnerability form 102 can be automated and performed in real-time. As described herein, the vulnerability form 102 specifies a vulnerability type (“VT”) and a plurality of steps (also referred to as “reproduction steps”) to reproduce a suspected bug of the software.

As shown, the computing system 100 includes an automated software vulnerability validation model 110 (or simply, “validation model”) that performs runtime analysis of the submitted vulnerability form 102 based on predefined scoring and probability modification techniques, and a model manager 150 responsible for maintaining and updating the validation criteria and training the model 110. In some examples, both the model 110 and model manager 150, including their components, can be implemented in software modules. Collectively, the model 110 and the model manager 150 can also be referred to as an ingenious model for automated software vulnerability validation.

The automated software vulnerability validation model 110 receives the vulnerability form 102 via an application programming interface, or API 112, which directs the form to a preprocessor 114. The preprocessor 114 can process the vulnerability form 102 by normalizing the text, extracting key information, and preparing the data for downstream analysis. The processed data can then be evaluated by multiple analyzers, each focusing on a distinct aspect of the vulnerability validation process.

Specifically, a keywords analyzer 120 can be configured to determine a first base model score 130 by identifying keywords within the vulnerability form 102 and summing their respective weights. Keywords can be defined in a keywords list 152 maintained by the model manager 150.

A context analyzer 122 can be configured to determine a second base model score 132 by assessing contextual information specific to the vulnerability type.

Together, the keywords analyzer 120 and the context analyzer 122 form a foundational base model that provides an initial assessment of the validity of the vulnerability form 102. Their respective base model scores (130 and 132) establish a preliminary confidence level, which can be further refined by additional analyzers that evaluate supporting evidence on form validity and produce corresponding probability modifiers.

Specifically, a feature analyzer 124 can be configured to evaluate specific characteristics of the vulnerability form 102 and determines a first probability modifier 134. Characteristics evaluated by the feature analyzer 124 can include whether a word in the vulnerability form 102 is listed in a vulnerability type-specific keywords dictionary 155 maintained by the model manager 150, whether the vulnerability form 102 indicates a vulnerability type-specific vulnerability mechanism indicated by a vulnerability type-specific mechanism dictionary 156, and whether the vulnerability form 102 is associated with at least one file attachment 104.

The validation model 110 further includes a step analyzer 128, which can examine the structure and logical flow of the reproduction steps in the vulnerability form 102. The step analyzer 128 can work in conjunction with an attachment analyzer 126 to match reported steps with extracted content from the file attachments 104. In some examples, such matching operation can be performed by a similarity analyzer 116.

The attachment analyzer 126 can be configured to processes file attachments 104, such as screenshots or videos, to extract relevant data, e.g., using an OCR engine 144 (for optical character recognition) and a video decoder 146. The extracted text and metadata can be used to determine a second probability modifier 136, which evaluates the degree of alignment between the attachments and the reproduction steps in the vulnerability form 102.

Additionally, the step analyzer 128 can be configured to apply logical consistency checks, including step pairing and grouping, to determine a third probability modifier 138, which further refines the validation confidence.

The base model scores (e.g., 130 and 132) and probability modifiers (e.g., 134, 136, and 138) are provided as inputs to a classifier 140, which is configured to determine a final vulnerability score. The classifier 140 can apply predefined weightages 142, e.g., to each probability modifier, to classify the vulnerability form 102 as valid or invalid. The classification result is output as a label 106, which indicate whether the vulnerability form 102 has been accepted as a valid security issue.

The model manager 150 plays an managerial role in maintaining and enhancing the accuracy of the validation model 110 based on a training database 180. The training database 180 stores historical vulnerability forms 182 with verified classification labels, which can be used as ground truth data for model improvements. An administrator 108, such as a security expert, can review classification results and, if correct, adds the corresponding vulnerability form 102 and the classification label 106 to the training database 180.

The model manager 150 can include a frequency analyzer 160 configured to periodically update the keywords list 152, which is used by the keywords analyzer 120. The frequency analyzer 160 can generate and update the keywords list 152 by analyzing the verified vulnerability forms 182, thereby ensuring that the validation model 110 adapts to emerging security trends.

The administrator 108 can also maintain a plurality of context dictionaries 154, a plurality of keywords dictionaries 155, a plurality of mechanism dictionaries 156, and a relation dictionary 158. Each context dictionary 154 corresponds to a specific vulnerability type, and is used by the context analyzer 122 to generate the second base model score 132. The keywords dictionaries 155 and mechanism dictionaries 156 also correspond to specific vulnerability types, and are used by the feature analyzer 124 to determine the first probability modifier 134. The relation dictionary 158 can be used by the step analyzer 128 to assess logical connections between reproduction steps, based on which to determine the third probability modifier 138.

In some examples, a training unit 170 can utilize the verified vulnerability forms 182 to train the validation model 110. During the training process, classification metrics such as precision, recall, F1 score, and accuracy can be employed to assess model performance. These metrics ensure that the validation model 110 achieves a balance between correctly identifying valid vulnerabilities and minimizing false positives or false negatives. Machine learning techniques, such as gradient descent, can be applied to optimize weightages 142 and various scaling factors applied by different analyzers within the validation model 110, improving classification accuracy and adaptability over time.

By leveraging structured validation techniques and a continuously improving knowledge base, the system 100 efficiently filters out invalid vulnerability submissions while prioritizing genuine security threats.

In practice, the systems shown herein, such as the computing system 100, can vary in complexity, with additional functionality, more complex components, and the like. For example, there can be additional functionality within the validation model 110. Additional components can be included to implement security, redundancy, load balancing, report design, data logging, and the like.

The described computing systems can be networked via wired or wireless network connections, including the Internet. Alternatively, systems can be connected through an intranet connection (e.g., in a corporate environment, government environment, or the like).

The computing systems 100 and any of the other systems described herein can be implemented in conjunction with any of the hardware components described herein, such as the computing systems described below (e.g., processing units, memory, and the like). In any of the examples herein, vulnerability forms, file attachments, base scores, probability modifiers, keywords lists, dictionaries, and the like can be stored in one or more computer-readable storage media or computer-readable storage devices. The technologies described herein can be generic to the specifics of operating systems or hardware and can be applied in any variety of environments to take advantage of the described features.

### Example Workflow for Runtime Automated Software Vulnerability Validation

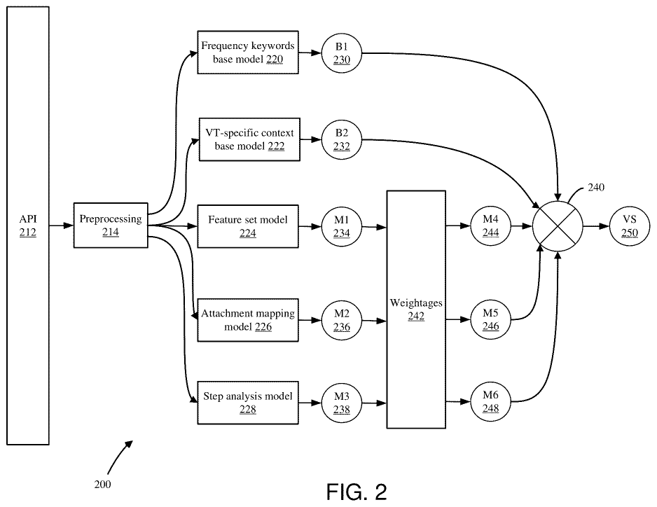

FIG. 2 is a block diagram depicting an example workflow or process 200 for runtime automated software vulnerability validation. The illustrated process 200 represents one possible, but non-limiting, operational flow for analyzing a submitted vulnerability form in an automated and real-time manner. As shown, the process 200 involves various processing components that assess different aspects of the vulnerability form to determine its validity without the need for manual intervention.

The process 200 begins when a vulnerability form is submitted via an application programming interface (API) 212 (similar to the API 112). The vulnerability form is then directed to a preprocessing module 214 (similar to the preprocessor 114), where text is normalized, key details are extracted, and the data is prepared for structured analysis. The preprocessed form is then evaluated by a series of models, each focusing on a different dimension of vulnerability validation.

A frequency keywords base model 220 (corresponding to the keywords analyzer 120) is configured to determine a first base model score (B1) 230 by identifying predefined keywords in the vulnerability form and assigning respective weights based on a stored keyword list. Additionally, a vulnerability type-specific context base model 222 (corresponding to the context analyzer 122) is configured to determine a second base model score (B2) 232 by analyzing contextual information in the vulnerability form. Details of obtaining the first and second base model scores B1 and B2 are described more fully below.

Beyond the base assessment, additional models refine the classification by incorporating supporting evidence. For example, a feature set model 224 (corresponding to the feature analyzer 124) is configured to determine a first probability modifier (M1) 234 based on specific characteristics of the vulnerability form. An attachment mapping model 226 (corresponding to the attachment analyzer 126) determines a second probability modifier (M2) 236 by analyzing file attachments (if any) associated with the vulnerability form and mapping extracted content to reproduction steps described in the vulnerability form. Further, a step analysis model 228 (corresponding to the step analyzer 128) is configured to determine a third probability modifier (M3) 238 by examining the logical sequence of reproduction steps and identifying step relationships. Details of determining the first, second, and third probability modifiers M1, M2, and M3 are described more fully below.

To ensure a balanced evaluation, weightages 242 (corresponding to weightages 142) can be applied to the probability modifiers M1, M2, and M3 to produce weighted probability modifiers M4 244, M5 246, and M6 248, respectively. These weighted modifiers ensure that different types of supporting evidence are appropriately factored into the final assessment based on appropriate weightages 242 (which can be trained or fine-tuned, e.g., using the training unit 170).

An aggregator 240 (which can be part of the classifier 140 in FIG. 1) can combine the outputs of the base models (B1 230, B2 232) and the weighted probability modifiers (M4 244, M5 246, M6 248) to compute a final vulnerability score (VS) 250. The computed VS 250 can then be compared to a predefined threshold to classify the submitted vulnerability form as either valid (e.g., if VS 250 is great than the threshold) or invalid (e.g., if VS 250 is less than or equal to the threshold).

### Example Vulnerability Forms and Vulnerability Types

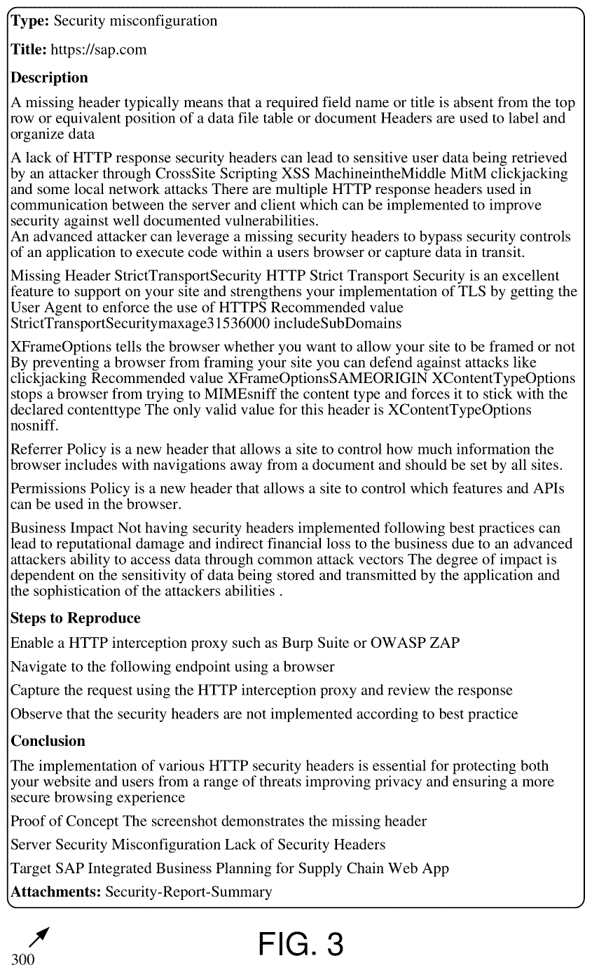

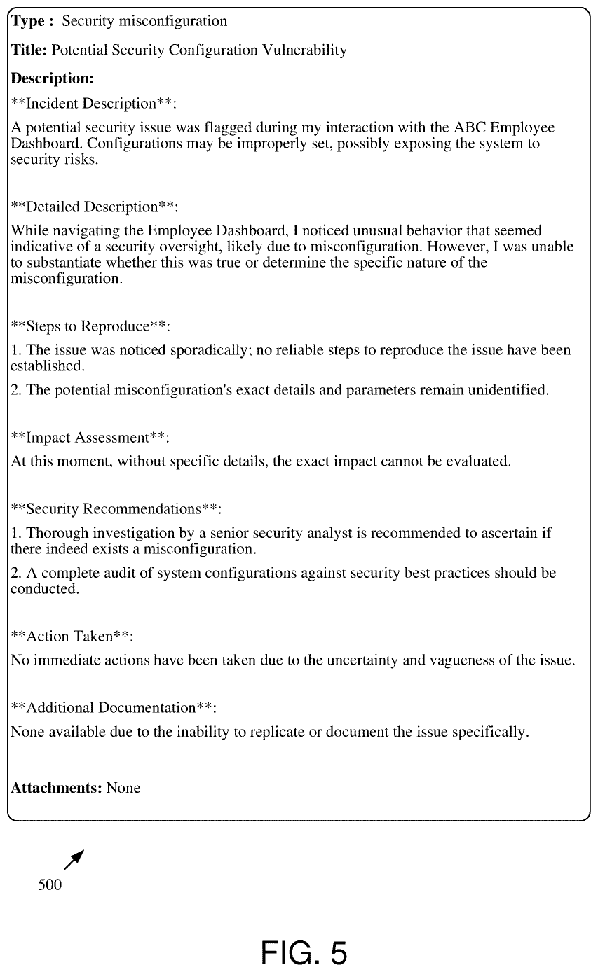

As examples, FIG. 3 and FIG. 5 depict two vulnerability forms 300, 500 submitted for software with suspected flaws. It should be understood that the depicted vulnerability forms 300, 500 are merely examples, and that the vulnerability forms can have different formats and/or content.

As shown, the vulnerability forms 300, 500 can be organized in a structured format, including multiple sections that allow the submitter to describe the suspected software flaw. Each vulnerability form can have a vulnerability type. For example, when submitting a vulnerability form, the submitter can be prompted to select, from a plurality of predefined vulnerability types, a specific vulnerability type that best describes the nature of the reported issue, such as Authentication Failure, Authorization Issues, Information Disclosure, Security Misconfiguration, and so on. Each vulnerability type represents a category of software vulnerability issues. The selected vulnerability type can be used to determine appropriate validation rules and contextual analysis applied during automated assessment of the vulnerability form.

In the depicted examples, each vulnerability form has a Title, which provides a brief summary of the reported vulnerability, followed by a Description section, where the submitter elaborates on the vulnerability, its potential impact, and how it might be exploited. The level of detail provided in this section can vary significantly between submissions, with some submitters offering an extensive analysis while others provide only a high-level summary.

Each vulnerability form can also include a Steps to Reproduce section, where the submitter describes the exact sequence of actions required to trigger the vulnerability. These steps may range from highly detailed multi-step procedures to brief, generalized instructions. Since a well-documented set of reproduction steps increases the likelihood of verification, the system analyzes this section using structural consistency checks and logical validation techniques, as described further below.

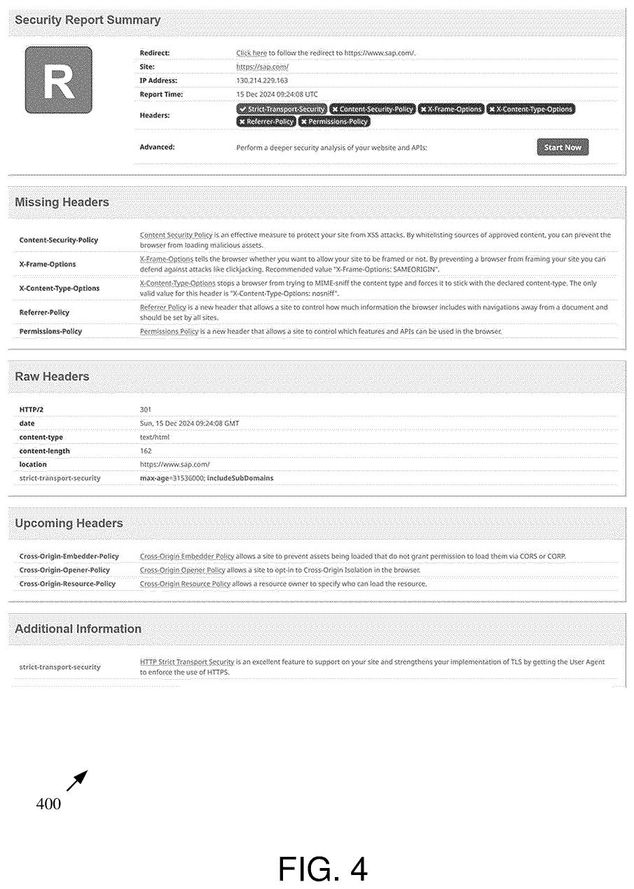

Additionally, the submitter may optionally attach one or more supporting files, such as screenshots or videos. Screenshots may correspond to specific reproduction steps, highlighting key observations or error messages encountered during the vulnerability discovery process. A video attachment may provide an alternative means of illustrating the vulnerability by capturing the sequence of actions taken to trigger the issue in real-time. The presence of attachments can significantly enhance the credibility of a submission and is factored into the automated validation process, as described further below. As an example, FIG. 4 depicts a screenshot 400 attached to the vulnerability form 300 of FIG. 3.

Beyond these structured sections, the form may also contain additional fields where the submitter can provide supplemental information or context that might aid in the validation process. While some submissions are thorough and well-documented, others may lack sufficient detail. The automated validation model described herein can process these various sections to ensure a systematic and objective evaluation of each reported vulnerability.

### Example Overall Method for Automated Software Vulnerability Validation

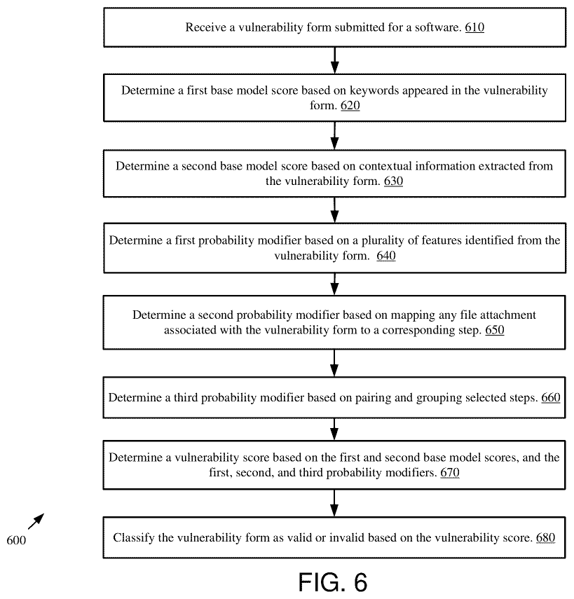

FIG. 6 is a flowchart illustrating an example overall method 600 for performing automated software vulnerability validation. The method 600 can be performed, e.g., by the computing system 100.

At step 610, the method can receive a vulnerability form submitted for a software (e.g., through the API 112). The vulnerability form can specify a vulnerability type and a plurality of steps to reproduce a suspected bug of the software.

At step 620, the method can determine a first base model score (e.g., 130) based on keywords appeared in the vulnerability form.

At step 630, the method can determine a second base model score (e.g., 132) based on vulnerability type-specific contextual information extracted from the vulnerability form.

At step 640, the method can determine a first probability modifier (e.g., 134) based on a plurality of features identified from the vulnerability form.

At step 650, the method can determine a second probability modifier (e.g., 136) based on mapping any file attachment associated with the vulnerability form to a corresponding step among the plurality of steps.

At step 660, the method can determine a third probability modifier (e.g., 138) based on pairing and grouping selected steps among the plurality of steps.

At step 670, the method can determine a vulnerability score based on the first base model score, the second base model score, the first probability modifier, the second probability modifier, and the third probability modifier.

Then, at step 680, the method can classify (e.g., by the classifier 140) the vulnerability form as valid or invalid based on the vulnerability score.

In some examples, determining the first base model score can include identifying words in the vulnerability form that have matching keywords and summing weights of the matching keywords. The keywords and their corresponding weights can be included in a keywords list (e.g., 152).

In some examples, the method can further include updating the keywords lists (e.g., by the frequency analyzer 160). The updating can include the following steps: collecting a plurality of vulnerability forms that have been classified to be valid, for words appearing in the plurality of vulnerability forms, determining respective word frequency and document frequency, calculating factors associated with the words, sorting the words based on the factors; identifying a subset of the words with top N factors as keywords, (N is a predefined integer), and assigning weights to the keywords. The word frequency of a selected word represents a count of the selected word appeared in the plurality of vulnerability forms. The document frequency of the selected word represents a count of vulnerability forms in which the selected word appears. The factor associated with the selected word represents a ratio of (i) a product of the word frequency and document frequency of the selected word, to (ii) a sum of the word frequency and document frequency of the selected word. The weight of a given keyword can be determined based on a ratio of (i) the factor of the given keyword to (ii) a sum of the factors of all keywords.

In some examples, determining the second base model score can include identifying words and phrases in the vulnerability form that are defined in a context dictionary that is specific to the vulnerability type, wherein the context dictionary assigns different context points to the words and phrases based on risk levels represented by the words and phrases for the vulnerability type, and summing the context points associated with the words and phrases.

In some examples, determining the first probability modifier includes identifying a first feature representing whether a word in the vulnerability form is listed in a keywords dictionary that is specific to the vulnerability type, identifying a second feature representing whether the vulnerability form indicates a vulnerability mechanism that is specific to the vulnerability type, and identifying a third feature representing whether the vulnerability form is associated with at least one file attachment.

In some examples, determining the second probability modifier includes retrieving one or more screenshots from one or more file attachments associated with the vulnerability form, extracting text from the one or more screenshots (e.g., using the OCR engine 144), measuring semantic similarity (e.g., using the similarity analyzer 116) between the text extracted from the one or more screenshots and text of the plurality of steps, and identifying one or more matching steps, among the plurality of steps, that are matched to the one or more screenshots based on the measured semantic similarity.

In some examples, determining the second probability modifier further includes evaluating a first condition to determine whether a first step and a last step, among the plurality of steps, have corresponding matching screenshots, evaluating a second condition to determine how many intermediate steps that are between the first step and the last step have corresponding matching screenshots, and evaluating a third condition to determine whether the one or more screenshots indicate usage of a vulnerability assessment tool for generating the vulnerability form. The second probability modifier can be determined based on evaluation results of at least the first condition, the second condition, and the third condition.

In some examples, determining the second probability modifier further includes retrieving one or more video frames from the one or more file attachments, extracting text from the one or more video frames (e.g., using the video decoder 146), and evaluating a fourth condition to determine whether one or more predefined terms appear in the text extracted from the one or more video frames. The second probability modifier can be further determined based on evaluation results of the fourth condition.

In some examples, determining the third probability modifier includes identifying a preceding step for a given matching step that is matched to a corresponding screenshot, wherein the preceding step is not matched to any screenshot, measuring semantic similarity between the text of the preceding step and the text of the given matching step, and responsive to finding that the semantic similarity is greater than a predefined threshold, paring the precedent step with the given matching step. The pairing can cause a corresponding first increase of the third probability modifier.

In some examples, determining the third probability modifier further includes identifying a subsequent step for the given matching step, wherein the subsequent step is not matched to any screenshot or paired with any other steps, detecting if there is a logical connection between the given matching step and the subsequent step, and responsive to detecting presence of the logical connection, grouping the given matching step and the subsequent step. The grouping can cause a corresponding second increase of the third probability modifier. The detecting can include searching a relation dictionary (e.g., 158) containing one or more pairs of first words and second words, and determining that the logical connection exists when a first word from any pair appears in the text of the given matching step and the corresponding second word appears in the text of the subsequent step.

The method 600 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “send” can also be described as “receive” from a different perspective.

### Example Preprocessing

As described above, the received vulnerability form can be preprocessed (e.g., by the preprocessor 114 or the preprocessing module 214) to clean and standardize its text to facilitate effective automated analysis. In some examples, the preprocessing can include converting all text to lowercase, ensuring uniformity across submissions. Punctuation and special characters can be removed to eliminate unnecessary symbols that do not contribute to meaningful analysis. The text can be tokenized to break it down into individual words for further processing. In some examples, common stopwords, such as “is,” “to,” and “for,” can be removed, as they do not provide significant contextual information. Lemmatization can be applied to reduce words to their base dictionary forms, helping to consolidate variations of the same word into a single representation. In some examples, a spell check can be performed to automatically correct any potential spelling errors.

### Example Frequency Keyword Base Model

As described herein, a frequency keyword base model can be used to assess the likelihood of a submitted vulnerability form being valid. This model can be configured to identify matching keywords within the vulnerability form and calculating a first base model score based on predefined keyword weights. As part of this process, a keywords analyzer (e.g., 120) or frequency keywords base model (e.g., 220) can evaluate the vulnerability form by extracting words and comparing them against a stored keywords list (e.g., 152). If words in the form match keywords in the list, their corresponding weights can be summed to determine the first base model score (e.g., 130 or 230).

By leveraging this keyword-matching technique, the frequency keyword base model provides an initial assessment of the likelihood that a submitted vulnerability form is valid. The resulting first base model score serves as a foundation upon which additional validation techniques, such as contextual analysis, attachment verification, logical consistency checks, etc., are applied to refine the final classification of the submission.

### Example Management of Keywords List

To maintain the accuracy and effectiveness of the frequency keyword base model, the keywords list can be dynamically updated based on verified vulnerability forms. This process can be managed by a frequency analyzer (e.g., 160), which periodically reviews a training database (e.g., 180) containing previously classified vulnerability forms with verified labels (e.g., 182).

In some examples, the frequency analyzer can process all valid vulnerability forms in the training database by counting the total occurrences of words across all valid submissions (“word frequency”) and determining how many distinct valid submissions contain each word (“document frequency”). Based on these statistics, the frequency analyzer can calculate a factor for each word using the formula:

$$Factor = \frac{Word Frequency \times Document Frequency}{Word Frequency + Document Frequency}$$

This formula ensures that keywords are selected not only based on how frequently they appear in individual vulnerability forms but also on how widely they occur across multiple valid vulnerability forms. By incorporating document frequency, the frequency analyzer avoids over-reliance on words that might be overly common in one form but not broadly relevant across different valid submissions. Moreover, the above formular allows the frequency analyzer to refine keyword selection by assigning lower importance to words that appear across multiple vulnerability types while giving higher importance to words that are uniquely associated with a specific vulnerability type, ensuring that the model effectively captures the contextual relevance of keywords for each category of vulnerabilities.

After the factor values are determined, the frequency analyzer can sort words in descending order of importance and selects the top N words (where N can be 50 or another predefined number) as keywords for the model. Each keyword can then be assigned a weight based on its relative factor score:

$$Keyword Weight = \frac{Factor of the Keyword}{\sum Factors of All Se1ected Keywords}$$

This ensures that keywords with higher statistical significance contribute more to the base model score than those with lower importance. The updated keywords list can then be used by the keywords analyzer to evaluate new vulnerability submissions, helping the validation model stay adaptive to evolving security trends. Additionally, by continuously refining the keywords list and weighting scheme based on verified vulnerability forms, the validation model enhances its ability to distinguish valid security threats from false positives, improving the overall efficiency and accuracy of automated vulnerability validation.

### Example Vulnerability Type-Specific Context Base Model

As described herein, a vulnerability type-specific context base model can be used to evaluate submitted vulnerability forms by considering contextual indicators relevant to each vulnerability type. Specifically, a context analyzer (e.g., 122) or a vulnerability type-specific context base model (e.g., 222) can process a vulnerability form by referencing a context dictionary (e.g., 154) that is specific to the vulnerability type of the vulnerability form. Using natural language processing techniques, the context analyzer or context base model can extract words and phrases from the vulnerability form and check their presence in the context dictionary. Each entry in the dictionary can be assigned a predefined context score based on its risk level, e.g., high-risk terms receive higher scores (e.g., 5 points), followed by medium-risk (e.g., 4 points), low-risk (e.g., 3 points), informational sentences (e.g., 2 points), and important words (e.g., 1 point). The total context score can then be computed by summing the individual scores of all matched words and phrases. The total context score can be converted to a second base model score (e.g., 132 or 232), e.g., by using a predefined scaling formula. One exemplary, non-limiting scaling formula can set the second base model score to 0.4 when the total context score exceeds 10 or falls within the range of 7-10, 0.3 when the total context score is between 3 and 6, 0.2 when the total context score is between 2 and 4, and 0.1 when the total context score is 1.

An example context dictionary for the vulnerability type of Authorization Issues can define the following entries:

```
authorization_issues_scoring = {
  ‘high_risk’: [
    ‘unauthorized access’,
    ‘permission bypass’,
    ‘elevated privileges’,
    ‘access control bypass’,
    ‘admin privileges gained’,
    ‘security policy bypass’
  ],
  ‘medium_risk’: [
    ‘insufficient authorization’,
    ‘weak role validation’,
    ‘improper access constraints’,
    ‘token manipulation’,
    ‘privileges escalation potential’,
    ‘unvalidated redirects’
  ],
  ‘low_risk’: [
    ‘inadequate session expiration’,
    ‘missing function level access control’,
    ‘insecure direct object references’,
    ‘lack of resource and rate limiting’
  ],
  ‘informational’: [
    ‘role definition unclear’,
    ‘failure to enforce step-up authentication’,
    ‘logging of failed authorization attempts’,
    ‘use of default credentials’
  ]
  ‘important_words’: [
    ‘access’,
    ‘role’,
    ‘authorization’,
    ‘permissions’,
    ‘privileges’,
    ‘credentials’,
    ‘token’,
    ‘session’,
    ‘authenticate’,
    ‘secure’,
    ‘policy’,
    ‘admin’,
    ‘user’
}
```

In some examples, entries in the context dictionary (e.g., the list of important words) can be periodically and/or dynamically updated and ranked so that the popular words will stay on the top of the list, e.g., based on verified vulnerability forms (e.g., 182) stored in a training database (e.g., 180).

### Example Feature Set

As described herein, a feature set model (e.g., 224) or feature analyzer (e.g., 124) can evaluate key features present in a submitted vulnerability form to determine a first probability modifier (e.g., 134 or 234) that influences the overall vulnerability classification. The feature set model operates by extracting structured attributes from the vulnerability form and assessing their relevance based on predefined criteria. Three exemplary features contributing to the first probability modifier include: (1) a first feature representing whether a word in the vulnerability form is listed in a keywords dictionary that is specific to the vulnerability type; (2) a second feature representing whether the vulnerability form indicates a vulnerability mechanism that is specific to the vulnerability type; and (3) a third feature representing whether the vulnerability form is associated with at least one file attachment.

To determine the first feature, the feature set model references a vulnerability type-specific keywords dictionary (e.g., 155) that defines keywords indicative of different categories of vulnerabilities. If a vulnerability form contains one or more keywords listed in the dictionary for its respective vulnerability type, the feature set model increases confidence in the validity of the submission by marking the corresponding feature as 1. That is, the presence of such keywords serves as an initial indicator that the vulnerability form is more likely to describe a genuine security vulnerability.

To determine the second feature, the feature set model references a vulnerability type-specific mechanism dictionary (e.g., 156) that defines security mechanisms relevant to different types of vulnerabilities. The model evaluates whether the vulnerability form indicates a mechanism corresponding to its assigned vulnerability type. If such mechanism is identified within the form, the second feature is marked as 1, indicating increased confidence in the validity of the submission. Otherwise, the second feature is marked as 0.

To determine the third feature, the feature set model evaluates whether the vulnerability form includes at least one file attachment. File attachments provide supporting evidence for the reported vulnerability, increasing confidence in its validity. For example, if the form contains one or more file attachments, the third feature can be marked as 1; otherwise, it can be marked as 0.

In some examples, each feature can be assigned a corresponding modifier score. For example, if the first feature (presence of a vulnerability-type-specific keyword) is marked as 1, a modifier score of 0.2 can be added. Similarly, if the second feature (presence of a vulnerability-type-specific mechanism) is marked as 1, an additional modifier score of 0.2 can be applied. If the third feature (presence of at least one file attachment) is marked as 1, a modifier score of 0.1 can be added. The first probability modifier (e.g., 134 or 234) can then be determined by summing the individual modifier scores from all three features.

### Example Keywords Dictionaries

The following lists exemplary, non-limiting, keywords dictionaries for four different vulnerability types:

Authorization Issues Keywords Dictionary: [‘access', ‘role’, ‘authorization’, ‘permissions',
‘privileges', ‘credentials', ‘token’, ‘session’, ‘authenticate’, ‘secure’, ‘policy’, ‘admin’, ‘user’]
Authentication Failure Keywords Dictionary: [‘login’, ‘password’, ‘credentials',
‘authentication’, ‘session’, ‘token’, ‘multi-factor authentication’, ‘session cookies', ‘challenge’,
‘OTP’, ‘security questions', ‘authentication method’]
Information Disclosure Keywords Dictionary: [‘exposure’, ‘leak’, ‘disclosure’, ‘dump’,
‘exposed’, ‘visible’, ‘public’, ‘sensitive’, ‘credentials', ‘keys', ‘data’, ‘details']
Security Misconfiguration Keywords Dictionary: [‘configuration’, ‘misconfiguration’,
‘default’, ‘exposed’, ‘vulnerable’, ‘insecure’, ‘security’, ‘firewall’, ‘encryption’, ‘SSL’, ‘TLS’,
‘server’, ‘storage’, ‘network’]

In some examples, the important words listed in the context dictionaries (e.g., 154) can overlap with the keywords listed in the keywords dictionaries (e.g., 155). In some examples, the keywords dictionaries can be periodically and/or dynamically updated, e.g., based on verified vulnerability forms (e.g., 182) stored in a training database (e.g., 180).

### Example Mechanism Dictionaries

As described above, vulnerability type-specific mechanism dictionaries can be used to assess whether a reported vulnerability form describes security mechanisms relevant to its assigned vulnerability type. As examples, four mechanism dictionaries corresponding to four different vulnerability types are described below.

If a vulnerability form describes an authorization before authentication, it indicates a potential flaw in security design, and the second feature can be marked as 0. Otherwise, the second feature can be marked as 1. The mechanism dictionary for the Authorization Issue vulnerability type can define words indicating authentication and authorization, respectively. For example, Authentication=[‘authenticate’, ‘login’, ‘sign’, ‘log’]; and Authorization=[‘access’, ‘role’, ‘authorization’, ‘permissions’, ‘privileges’, ‘credentials’, ‘token’, ‘session’, ‘authenticate’, ‘secure’, ‘policy’, ‘admin’, ‘user’].

Authentication failures occur when security mechanisms meant to verify user identity are weak, improperly implemented, or bypassed. If a vulnerability form references a known authentication mechanism indicated by the mechanism dictionary, the second feature can be marked as 1; otherwise, it can be marked as 0. The mechanism dictionary for the Authentication Failure vulnerability type can include the following terms: [“2FA”, “MFA”, “CAPTCHA”, “Biometric”, “SSO”, “Token-Based Authentication”, “Security Questions”, “Email/SMS Authentication”, “Hardware Authentication”, “Behavioral Biometrics”, “OAuth”, “OpenID Connect”, “Smart Cards”, “Risk-Based Authentication (RBA)”, “Decentralized Authentication”].

Information disclosure vulnerabilities arise when sensitive data is unintentionally exposed due to improper security controls. If a vulnerability form references a known information disclosure mechanism indicated by the mechanism dictionary, the second feature can be marked as 1; otherwise, it can be marked as 0. The mechanism dictionary for the Information Disclosure vulnerability type can include the following terms: [“Misconfigured permissions”, “Verbose error messages”, “Lack of encryption”, “Insecure API endpoints”, “Insufficient data access controls”, “Improper session handling”, “Exposure of sensitive data in logs”, “Unprotected filesystems”, “Insecure direct object references”, “Lack of rate limiting”, “Weak authentication mechanisms”, “Insufficient separation of environments”, “Misconfigured cloud storage”, “Data leakage through third-party services”, “Misuse of debug and development modes” ].

Security misconfigurations occur when systems are deployed with weak or default settings, exposing them to potential threats. If a vulnerability form references a security misconfiguration mechanism indicated by the mechanism dictionary, the second feature can be marked as 1; otherwise, it can be marked as 0. The mechanism dictionary for the Security Misconfiguration vulnerability type can include the following terms: [“Missing security headers”, “Default accounts still enabled”, “Unchanged default credentials”, “Open cloud storage buckets”, “Verbose error messages enabled”, “Outdated software versions”, “Enabled directory listing”, “Unsecured endpoints”, “Lack of secure cookie flags”, “Missing CORS policy”, “Incorrect file permissions”, “Weak encryption settings”, “Lack of network segmentation”, “Unrestricted IP whitelisting”, “Insufficient logging and monitoring”, “Improper access controls”, “Lack of two-factor authentication”, “Exposed administrative interfaces”, “Failure to disable unused services”, “Incorrect server configurations”, “Unpatched vulnerabilities”, “Overprivileged accounts” ].

In some examples, the mechanism dictionaries can be periodically and/or dynamically updated, e.g., based on verified vulnerability forms (e.g., 182) stored in a training database (e.g., 180).

### Example Attachment Mapping

As described above, a second probability modifier (e.g., 136 or 236) can be determined by analyzing file attachments submitted with a vulnerability form. File attachments, such as screenshots, serve as supporting evidence for the reported issue. By mapping screenshots to specific steps to reproduce, confidence in the validity of the submission can be increased.

To perform this evaluation, textual information from screenshots can be extracted and matched with steps documented in the vulnerability form. In some examples, an attachment mapping model (e.g., 226) or an attachment analyzer (e.g., 126) can extract text in the screenshots (which may be highlighted), e.g., using an OCR engine (e.g., 144). Extracted text can be stored in a structured format for later comparison. In some examples, a step analyzer (e.g., 128) or a step analysis model (e.g., 228) can extract sequential steps or reproduction steps described in the vulnerability form (e.g., in the “steps to reproduce” section), and assigns a step number to each step.

After the screenshot text and steps to reproduce are extracted, the attachment analyzer can measure semantic similarity between them (e.g., using the similarity analyzer 116). For example, the attachment analyzer can iterate through each screenshot, preprocesses the extracted text, and compare it with each step using cosine similarity or another similarity metric. The attachment analyzer can identify the step with the highest similarity score that exceeds a predefined threshold and map the screenshot to that step. In some examples, a hash map can be used to store these mappings, where the step number serves as the key and the screenshot index as the value.

In some examples, multiple conditions can be evaluated to define the second probability modifier (e.g., 136 or 236). For example, evaluation of each condition can generate a corresponding condition score, and the second probability modifier can be calculated as the sum of all condition scores.

For a first condition, if a screenshot is mapped to either the first or the last step, confidence in the validity of the vulnerability form can be increased (as it demonstrates that the start or end of the reported issue is well-documented). In a non-limiting example, a condition score of 0.1 can be assigned for each start or end match, resulting in a combined increase of 0.2 if both the first and last steps have matching screenshots.

For a second condition, confidence can be further refined based on the number of intermediate steps that have matching screenshots. If multiple intermediary steps between the first and last step are matched with screenshots, this suggests that the vulnerability is well-supported by evidence. The corresponding condition score can be calculated using the following formula:

$$score = \frac{X}{K 1 \times S} ,$$

where X represents the number of matched intermediary steps, S represents the total number of steps in the form, and K1 can be a predefined factor (e.g., K1=2.5).

For a third condition, if the screenshots contain evidence of a known vulnerability assessment tool, such as Burp Suite or the like, it indicates that the person who submitted the vulnerability form has performed a validation process. In such cases, an additional conditional score of (e.g., 0.1) can be applied.

A fourth condition can be evaluated if the attachments include a video file. In this case, the attachment analyzer can extract frames from the video (e.g., using the video decoder 146) at fixed intervals and apply OCR to retrieve text from the extracted frames. The content of the video may provide additional evidence supporting the reported vulnerability. For example, the attachment analyzer can evaluate whether certain predefined terms appear in the extracted text. These predefined terms can include indicators of vulnerability assessment tools (e.g., “Burp Suite” or the like) to confirm that the submitter has actively validated the vulnerability, action-related terms (e.g., “Update,” “Submit,” or the like) that suggest modifications were made in the process, HTTP server response codes that indicate interaction with a system component during the vulnerability test, success messages confirming that the reported issue resulted in an observable security impact, etc. If any of these predefined terms appear in the extracted text, the attachment analyzer can update a feature mapping structure, such as a hash map, marking each detected term as 1. The corresponding condition score can be calculated based on the proportion of detected terms relative to the total number of features analyzed, e.g.,

$$\frac{Y}{K 2 \times F} ,$$

wherein Y is the total number of detected terms, F is the total number of features, and K2 can be a predefined factor (e.g., K2=2.5).

### Example Step Pairing and Grouping

As described herein, a step analyzer (e.g., 128) or step analysis model (e.g., 228) can perform step pairing and grouping operations to generate a third probability modifier (e.g., 138 or 238). Pairing and grouping of steps are useful for validating vulnerabilities where not all steps explicitly contain supporting screenshots. Some steps may act as prerequisites or logically follow from others, even if they do not have direct screenshot evidence. By analyzing the relationships between steps, the system can infer whether missing steps were likely processed correctly, thereby increasing confidence in the vulnerability validation.

The step pairing process begins by identifying preceding steps for given steps that have already been matched with screenshots (also referred to as “primary steps”). If a preceding step does not have a matching screenshot, the semantic similarity (e.g., cosine similarity) between its text and the text of the matched step can be measured (e.g., using the similarity analyzer 116). If the similarity exceeds a predefined threshold, the step analyzer can pair the preceding step with the matched step. This implies that the preceding step is likely a necessary prerequisite and should be considered validated by association. Each successful pairing can result in an increment (Δ) to the third probability modifier based on the number of total steps, e.g., using the formula:

$$Δ = \frac{1}{K 3 \times S} ,$$

where S represents the total number of steps in the vulnerability form, and K3 can be a predefined factor (e.g., K3=2.5).

The step grouping process ensures that logically connected steps are recognized even if they lack direct screenshot evidence. After all step pairings are completed, the step analyzer can iterate through the steps again and group unpaired steps adjacent to primary steps (i.e., steps that were previously matched to screenshots). To determine whether a grouping is valid, the step analyzer can search a relation dictionary (e.g., 158) containing pairs of related terms. If a word in the given step appears in the relation dictionary alongside a corresponding word in the subsequent step, the step analyzer can establish a logical connection between these two steps. If, and only if, such a connection exists, these two steps can be grouped together, and an additional confidence score increment (A) can be applied to the third probability modifier.

In some examples, the step analyzer can also apply a boundary condition for the rightmost step (i.e., the last step) in the sequence. If the last step has already been paired with a preceding step (i.e., the second to last step), but a far-left step (i.e., the third to last step) remains unpaired, the step analyzer can attempt to establish a grouping between them. If a logical connection is found, the third to last step can be grouped with the last paired step, further increasing the confidence score. As a result, unpaired but contextually relevant steps are accounted for in the vulnerability validation process.

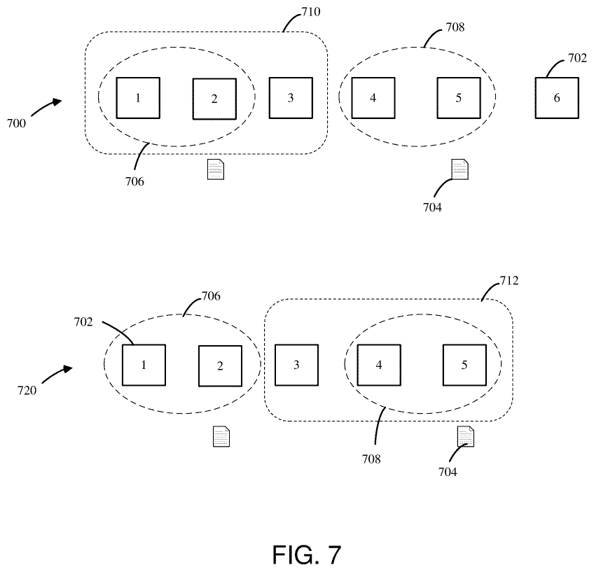

FIG. 7 schematically illustrates the pairing and grouping process using two example step sequences. The first example step sequence 700 illustrates an initial arrangement of individual steps 702, where steps 2 and 5 have matched attachments 704 (e.g., screenshots), making them primary steps. In the pairing stage, the step analyzer identifies steps that precede primary steps but lack direct screenshot evidence. As shown, step 1 is paired with step 2, forming the first identified step pair 706, while step 4 is paired with step 5, forming the second identified step pair 708. As described above, these pairings are based on semantic similarity analysis, where the text of an unmatched step is compared with the text of a primary step. If the similarity exceeds a predefined threshold, it can be inferred that the preceding step is a prerequisite and the two steps can form a pair, resulting in a corresponding increment to the third probability modifier. Next, in the grouping stage, the step analyzer evaluates whether logically connected steps should be grouped. In the first example, step 3, which is neither paired nor directly matched with an attachment, is found to have a logical connection (e.g., based on related terms in a relation dictionary) with step 2. Thus, a large group set 710 is formed, causing a corresponding increment to the third probability modifier.

In the second example step sequence 720, the step analyzer identifies a boundary condition where step 5 is the last step, step 4 is the second to last step, and step 3 is the third to last step. Similarly, step 1 is paired with step 2, forming the first identified step pair 706, and step 4 is paired with step 5, forming the second identified step pair 708. Since step 3 is unpaired, the step analyzer attempts to group it with the paired steps 4 and 5. In the depicted example, step 3 and step 4 are found to have a logical connection (e.g., based on related terms in a relation dictionary), a new group 712 is confirmed, causing a corresponding increment to the third probability modifier.

### Example Relation Dictionary

As described above, a relation dictionary (e.g., 158) can be used to establish logical connections between two adjacent steps, denoted as S1 and S2, during the step grouping process. This dictionary includes word pairs, where the first word is expected to appear in S1, and the second word is expected to appear in S2. When evaluating whether two steps, S1 and S2, should be grouped, the step analyzer (e.g., 128) checks if the first word from any pair is present in S1 and if the corresponding second word appears in S2. If a match is found, the step analyzer determines that a logical connection exists between S1 and S2 and groups them accordingly. An exemplary relation can include pairs such as: [‘authenticate’: ‘navigate’], [‘proxy’: ‘change’], [‘http’: ‘modify’], [‘file’: ‘upload’], [‘account’: ‘delete’], [‘user’: ‘create’], [‘profile’: ‘update’], [‘database’: ‘search’], [‘software’: ‘install’], [‘network’: ‘configure’], [‘data’: ‘encrypt’], [‘input’: ‘validate’], [‘data’: ‘export’], [‘code’: ‘compile’], [‘command’: ‘execute’], [‘performance’: ‘monitor’], [‘database’: ‘backup’], etc. In some examples, the word pairs included in the relation dictionaries can be periodically and/or dynamically updated, e.g., based on verified vulnerability forms (e.g., 182) stored in a training database (e.g., 180).

### Example Classification of Vulnerability Validity

As described above, a classifier (e.g., 140) can determine whether a submitted vulnerability form is valid or invalid by computing a vulnerability score (e.g., 250). The vulnerability score can be derived by combining the first base model score (e.g., 230) and second base model score (e.g., 232) with the first, second, and third probability modifiers (e.g., 234, 236, and 238). In some examples, the combination process can apply weightages (e.g., 242) to each probability modifier (e.g., 244, 246, and 248) to ensure that different aspects of the validation contribute appropriately to the final vulnerability score. For example, the vulnerability score can be calculated using the weighted sum formula below:

Vulnerability Score=B1+B2+(M1×W1)+(M2×W2)+(M3×W3)

Here, B1 and B2 represent the first and second base model scores, M1, M2, and M3 represent the first, second, and third probability modifiers, and W1, W2, and W3 are their respective weightages. In one specific example, W1=0.25, W2=0.5, and W3=0.25. In some examples, the weightages can be adjusted during model training (e.g., using the training unit 170).

The calculated vulnerability score can be compared to a predefined threshold (e.g., 0.85) to determine whether the vulnerability form should be classified as valid or invalid. For example, if the vulnerability score exceeds the threshold, the vulnerability form can be classified as valid; otherwise, the form can be deemed invalid. As an example, the vulnerability form 300 of FIG. 3 had a combined base model score (B1+B2) of 0.866, with additional increases of 0.075 from probability modifiers. The computed vulnerability score was 0.941, exceeding the 0.85 threshold. Thus, the vulnerability form 300 is classified as valid. As another example, the vulnerability forms 500 of FIG. 5 has a combined base model score (B1+B2) of 0.532, with probability modifiers contributing an additional 0.05 increase. The computed vulnerability score was 0.582, which falls below the 0.85 threshold. As a result, the vulnerability form 500 is classified as invalid.

### Example Advantages

As described above, traditional software vulnerability validation methods rely heavily on manual review processes, where security teams sift through large volumes of reported vulnerabilities. These manual approaches suffer from several shortcomings, including high false positive rates, over-reliance on static keyword-based filtering, and limited contextual awareness when evaluating reported vulnerabilities. Additionally, existing automated rule-based validation techniques often fail to capture the nuanced relationships between reported steps, attachments, and supporting evidence, leading to misclassifications that require further manual intervention. The ingenious model described herein offer several technical advantages that address these challenges.

First, the disclosed technologies provide a structured and multi-layered approach that significantly enhances the accuracy and efficiency of vulnerability validation. Unlike conventional systems that rely solely on static keyword-based filtering, the disclosed dual-layer base model integrates a frequency keyword base model with a vulnerability-type-specific context base model. The frequency keyword base model scores keywords based on statistical significance across verified vulnerability reports, while the context base model refines classification by assessing vulnerability-type-specific contextual indicators from structured context dictionaries. By combining traditional keyword analysis with structured context evaluation, this hybrid approach leverages contextual information to distinguish truly relevant vulnerabilities from unrelated reports, even when they share similar terminology, thereby reducing false positives and improving classification precision.

Additionally, the disclosed approach introduces multiple probability modifiers that further enhance the validation process. Attachment mapping ensures that supporting evidence, such as screenshots and videos, is properly correlated with the reported reproduction steps, increasing confidence in vulnerabilities that include visual proof. Further, step pairing and grouping allow the validation system to infer logical connections between steps that may lack direct attachments but are contextually linked. As a result, vulnerability forms containing unmatched but essential prerequisite steps are not incorrectly dismissed due to missing screenshots. The structured integration of these probability modifiers refines the vulnerability score, leading to more accurate classifications while reducing false positives and negatives.

The structured evaluation process described herein can not only improve the accuracy of vulnerability validation but also enhance automation by minimizing manual security team interventions. The automated software vulnerability validation system disclosed herein provides an adaptive and scalable vulnerability assessment framework, by means of which software security teams can prioritize truly critical vulnerabilities, reduce the burden of manual verification, and streamline security workflows in modern, complex software environments.

### Example Computing Systems

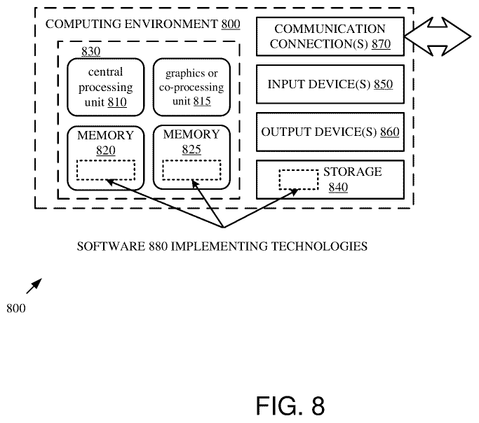

FIG. 8 depicts an example of a suitable computing system 800 in which the described innovations can be implemented. The computing system 800 is not intended to suggest any limitation as to scope of use or functionality of the present disclosure, as the innovations can be implemented in diverse computing systems.

With reference to FIG. 8, the computing system 800 includes one or more processing units 810, 815 and memory 820, 825. In FIG. 8, this basic configuration 830 is included within a dashed line. The processing units 810, 815 can execute computer-executable instructions, such as for implementing the features described in the examples herein (e.g., the method 600). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 8 shows a central processing unit 810 as well as a graphics processing unit or co-processing unit 815. The tangible memory 820, 825 can be volatile memory (e.g., registers, cache, RAM), non-volatile memory (e.g., ROM, EEPROM, flash memory, etc.), or some combination of the two, accessible by the processing unit(s) 810, 815. The memory 820, 825 can store software 880 implementing one or more innovations described herein, in the form of computer-executable instructions suitable for execution by the processing unit(s) 810, 815.

A computing system 800 can have additional features. For example, the computing system 800 can include storage 840, one or more input devices 850, one or more output devices 860, and one or more communication connections 870, including input devices, output devices, and communication connections for interacting with a user. An interconnection mechanism (not shown) such as a bus, controller, or network can interconnect the components of the computing system 800. Typically, operating system software (not shown) can provide an operating environment for other software executing in the computing system 800, and coordinate activities of the components of the computing system 800.

The tangible storage 840 can be removable or non-removable, and includes magnetic disks, magnetic tapes or cassettes, CD-ROMs, DVDs, or any other medium which can be used to store information in a non-transitory way and which can be accessed within the computing system 800. The storage 840 can store instructions for the software implementing one or more innovations described herein.

The input device(s) 850 can be an input device such as a keyboard, mouse, pen, or trackball, a voice input device, a scanning device, touch device (e.g., touchpad, display, or the like) or another device that provides input to the computing system 800. The output device(s) 860 can be a display, printer, speaker, CD-writer, or another device that provides output from the computing system 800.

The communication connection(s) 870 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Cloud Computing Environment

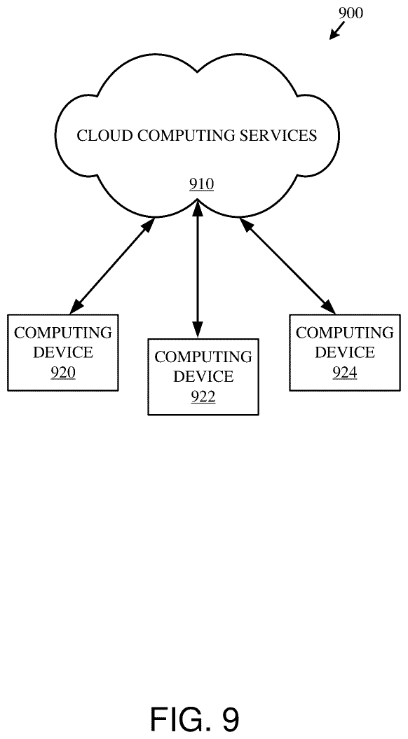

FIG. 9 depicts an example cloud computing environment 900 in which the described technologies can be implemented, including, e.g., the system 100 and other systems herein. The cloud computing environment 900 can include cloud computing services 910. The cloud computing services 910 can comprise various types of cloud computing resources, such as computer servers, data storage repositories, networking resources, etc. The cloud computing services 910 can be centrally located (e.g., provided by a data center of a business or organization) or distributed (e.g., provided by various computing resources located at different locations, such as different data centers and/or located in different cities or countries).

The cloud computing services 910 can be utilized by various types of computing devices (e.g., client computing devices), such as computing devices 920, 922, and 924. For example, the computing devices (e.g., 920, 922, and 924) can be computers (e.g., desktop or laptop computers), mobile devices (e.g., tablet computers or smart phones), or other types of computing devices. For example, the computing devices (e.g., 920, 922, and 924) can utilize the cloud computing services 910 to perform computing operations (e.g., data processing, data storage, and the like).

In practice, cloud-based, on-premises-based, or hybrid scenarios can be supported.

### Example Implementations

In any of the examples herein, a software application (or “application”) can take the form of a single application or a suite of a plurality of applications, whether offered as a service (SaaS), in the cloud, on premises, on a desktop, mobile device, wearable, or the like.

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

Although specific prompt templates are described above, it should be understood that these prompt templates are merely examples for illustration purposes, and different prompt templates can be used based on the principles described herein.

In any of the examples described herein, an operation performed in runtime or real-time means that the operation can be completed with negligible processing latency (e.g., the operation can be completed within 1 second, etc.).

### Example Clauses

Any of the following example clauses can be implemented.

Clause 1. A computing system comprising: memory; one or more hardware processors coupled to the memory; and one or more computer readable storage media storing instructions that, when loaded into the memory, cause the one or more hardware processors to perform operations comprising: receiving a vulnerability form submitted for a software, wherein the vulnerability form specifies a vulnerability type and a plurality of steps to reproduce a suspected bug of the software; determining a first base model score based on keywords appeared in the vulnerability form; determining a second base model score based on vulnerability type-specific contextual information extracted from the vulnerability form; determining a first probability modifier based on a plurality of features identified from the vulnerability form; determining a second probability modifier based on mapping any file attachment associated with the vulnerability form to a corresponding step among the plurality of steps; determining a third probability modifier based on pairing and grouping selected steps among the plurality of steps; determining a vulnerability score based on the first base model score, the second base model score, the first probability modifier, the second probability modifier, and the third probability modifier; and classifying the vulnerability form as valid or invalid based on the vulnerability score.

Clause 2. The computing system of clause 1, wherein determining the first base model score comprises: identifying words in the vulnerability form that have matching keywords included in a keywords list, the keywords list further including weights of the matching keywords; and summing the weights of the matching keywords.

Clause 3. The computing system of clause 2, wherein the operations further comprise updating the keywords list, comprising: collecting a plurality of vulnerability forms that have been classified to be valid; for words appearing in the plurality of vulnerability forms, determining respective word frequency and document frequency, wherein the word frequency of a selected word represents a count of the selected word appeared in the plurality of vulnerability forms, wherein the document frequency of the selected word represents a count of vulnerability forms in which the selected word appears; calculating factors associated with the words, wherein the factor associated with the selected word represents a ratio of (i) a product of the word frequency and document frequency of the selected word, to (ii) a sum of the word frequency and document frequency of the selected word; sorting the words based on the factors; identifying a subset of the words with top N factors as keywords, wherein N is a predefined integer; and assigning weights to the keywords, wherein the weight of a given keyword is determined based on a ratio of (i) the factor of the given keyword to (ii) a sum of the factors of all keywords.

Clause 4. The computing system of any one of clauses 1-3, wherein determining the second base model score comprises: identifying words and phrases in the vulnerability form that are defined in a context dictionary that is specific to the vulnerability type, wherein the context dictionary assigns different context points to the words and phrases based on risk levels represented by the words and phrases for the vulnerability type; and summing the context points associated with the words and phrases.

Clause 5. The computing system of any one of clauses 1-4, wherein determining the first probability modifier comprises: identifying a first feature representing whether a word in the vulnerability form is listed in a keywords dictionary that is specific to the vulnerability type; identifying a second feature representing whether the vulnerability form indicates a vulnerability mechanism that is specific to the vulnerability type; and identifying a third feature representing whether the vulnerability form is associated with at least one file attachment.

Clause 6. The computing system of any one of clauses 1-5, wherein determining the second probability modifier comprises: retrieving one or more screenshots from one or more file attachments associated with the vulnerability form; extracting text from the one or more screenshots; measuring semantic similarity between the text extracted from the one or more screenshots and text of the plurality of steps; and identifying one or more matching steps, among the plurality of steps, that are matched to the one or more screenshots based on the measured semantic similarity.

Clause 7. The computing system of clause 6, wherein determining the second probability modifier further comprises: evaluating a first condition to determine whether a first step and a last step, among the plurality of steps, have corresponding matching screenshots; evaluating a second condition to determine how many intermediate steps that are between the first step and the last step have corresponding matching screenshots; and evaluating a third condition to determine whether the one or more screenshots indicate usage of a vulnerability assessment tool for generating the vulnerability form, wherein the second probability modifier is determined based on evaluation results of at least the first condition, the second condition, and the third condition.

Clause 8. The computing system of any one of clauses 6-7, wherein determining the second probability modifier further comprises: retrieving one or more video frames from the one or more file attachments; extracting text from the one or more video frames; and evaluating a fourth condition to determine whether one or more predefined terms appear in the text extracted from the one or more video frames, wherein the second probability modifier is further determined based on evaluation results of the fourth condition.

Clause 9. The computing system of any one of clauses 6-8, wherein determining the third probability modifier comprises: identifying a preceding step for a given matching step that is matched to a corresponding screenshot, wherein the preceding step is not matched to any screenshot; measuring semantic similarity between the text of the preceding step and the text of the given matching step; and responsive to finding that the semantic similarity is greater than a predefined threshold, paring the preceding step with the given matching step, wherein the pairing causes a corresponding first increase of the third probability modifier.

Clause 10. The computing system of clause 9, wherein determining the third probability modifier further comprises: identifying a subsequent step for the given matching step, wherein the subsequent step is not matched to any screenshot or paired with any other steps; detecting if there is a logical connection between the given matching step and the subsequent step; and responsive to detecting presence of the logical connection, grouping the given matching step and the subsequent step, wherein the grouping causes a corresponding second increase of the third probability modifier, wherein the detecting comprises searching a relation dictionary containing one or more pairs of first words and second words, and determining that the logical connection exists when a first word from any pair appears in the text of the given matching step and the corresponding second word appears in the text of the subsequent step.

Clause 11. A computer-implemented method comprising: receiving a vulnerability form submitted for a software, wherein the vulnerability form specifies a vulnerability type and a plurality of steps to reproduce a suspected bug of the software; determining a first base model score based on keywords appeared in the vulnerability form; determining a second base model score based on vulnerability type-specific contextual information extracted from the vulnerability form; determining a first probability modifier based on a plurality of features identified from the vulnerability form; determining a second probability modifier based on mapping any file attachment associated with the vulnerability form to a corresponding step among the plurality of steps; determining a third probability modifier based on pairing and grouping selected steps among the plurality of steps; determining a vulnerability score based on the first base model score, the second base model score, the first probability modifier, the second probability modifier, and the third probability modifier; and classifying the vulnerability form as valid or invalid based on the vulnerability score.

Clause 12. The computer-implemented method of clause 11, wherein determining the first base model score comprises: identifying words in the vulnerability form that have matching keywords included in a keywords list, the keywords list further including weights of the matching keywords; and summing the weights of the matching keywords.

Clause 13. The computer-implemented method of clause 12, further comprising updating the keywords list, wherein the updating comprises: collecting a plurality of vulnerability forms that have been classified to be valid; for words appearing in the plurality of vulnerability forms, determining respective word frequency and document frequency, wherein the word frequency of a selected word represents a count of the selected word appeared in the plurality of vulnerability forms, wherein the document frequency of the selected word represents a count of vulnerability forms in which the selected word appears; calculating factors associated with the words, wherein the factor associated with the selected word represents a ratio of (i) a product of the word frequency and document frequency of the selected word, to (ii) a sum of the word frequency and document frequency of the selected word; sorting the words based on the factors; identifying a subset of the words with top N factors as keywords, wherein N is a predefined integer; and assigning weights to the keywords, wherein the weight of a given keyword is determined based on a ratio of (i) the factor of the given keyword to (ii) a sum of the factors of all keywords.

Clause 14. The computer-implemented method of any one of clauses 11-13, wherein determining the second base model score comprises: identifying words and phrases in the vulnerability form that are defined in a context dictionary that is specific to the vulnerability type, wherein the context dictionary assigns different context points to the words and phrases based on risk levels represented by the words and phrases for the vulnerability type; and summing the context points associated with the words and phrases.

Clause 15. The computer-implemented method of any one of clauses 11-14, wherein determining the first probability modifier comprises: identifying a first feature representing whether a word in the vulnerability form is listed in a keywords dictionary that is specific to the vulnerability type; identifying a second feature representing whether the vulnerability form indicates a vulnerability mechanism that is specific to the vulnerability type; and identifying a third feature representing whether the vulnerability form is associated with at least one file attachment.

Clause 16. The computer-implemented method of any one of clauses 11-15, wherein determining the second probability modifier comprises: retrieving one or more screenshots from one or more file attachments associated with the vulnerability form; extracting text from the one or more screenshots; measuring semantic similarity between the text extracted from the one or more screenshots and text of the plurality of steps; and identifying one or more matching steps, among the plurality of steps, that are matched to the one or more screenshots based on the measured semantic similarity.

Clause 17. The computer-implemented method of clause 16, wherein determining the second probability modifier further comprises: evaluating a first condition to determine whether a first step and a last step, among the plurality of steps, have corresponding matching screenshots; evaluating a second condition to determine how many intermediate steps that are between the first step and the last step have corresponding matching screenshots; and evaluating a third condition to determine whether the one or more screenshots indicate usage of a vulnerability assessment tool for generating the vulnerability form, wherein the second probability modifier is determined based on evaluation results of at least the first condition, the second condition, and the third condition.

Clause 18. The computer-implemented method of any one of clauses 16-17, wherein determining the third probability modifier comprises: identifying a preceding step for a given matching step that is matched to a corresponding screenshot, wherein the preceding step is not matched to any screenshot; measuring semantic similarity between the text of the preceding step and the text of the given matching step; and responsive to finding that the semantic similarity is greater than a predefined threshold, paring the preceding step with the given matching step, wherein the pairing causes a corresponding first increase of the third probability modifier.

Clause 19. The computer-implemented method of clause 18, wherein determining the third probability modifier further comprises: identifying a subsequent step for the given matching step, wherein the subsequent step is not matched to any screenshot or paired with any other steps; detecting if there is a logical connection between the given matching step and the subsequent step; and responsive to detecting presence of the logical connection, grouping the given matching step and the subsequent step, wherein the grouping causes a corresponding second increase of the third probability modifier, wherein the detecting comprises searching a relation dictionary containing one or more pairs of first words and second words, and determining that the logical connection exists when a first word from any pair appears in the text of the given matching step and the corresponding second word appears in the text of the subsequent step.

Clause 20. One or more non-transitory computer-readable media having encoded thereon computer-executable instructions causing one or more processors to perform a method, the method comprising: receiving a vulnerability form submitted for a software, wherein the vulnerability form specifies a vulnerability type and a plurality of steps to reproduce a suspected bug of the software; determining a first base model score based on keywords appeared in the vulnerability form; determining a second base model score based on vulnerability type-specific contextual information extracted from the vulnerability form; determining a first probability modifier based on a plurality of features identified from the vulnerability form; determining a second probability modifier based on mapping any file attachment associated with the vulnerability form to a corresponding step among the plurality of steps; determining a third probability modifier based on pairing and grouping selected steps among the plurality of steps; determining a vulnerability score based on the first base model score, the second base model score, the first probability modifier, the second probability modifier, and the third probability modifier; and classifying the vulnerability form as valid or invalid based on the vulnerability score.

The technologies from any clause can be combined with the technologies described in any one or more of the other clauses.

In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
memory;
one or more hardware processors coupled to the memory; and
one or more computer readable storage media storing instructions that, when loaded into the memory, cause the one or more hardware processors to perform operations comprising:
receiving a vulnerability form submitted for a software, wherein the vulnerability form specifies a vulnerability type and a plurality of steps to reproduce a suspected bug of the software;
determining a first base model score based on keywords appeared in the vulnerability form;
determining a second base model score based on vulnerability type-specific contextual information extracted from the vulnerability form;
determining a first probability modifier based on a plurality of features identified from the vulnerability form;
determining a second probability modifier based on mapping any file attachment associated with the vulnerability form to a corresponding step among the plurality of steps;
determining a third probability modifier based on pairing and grouping selected steps among the plurality of steps;
determining a vulnerability score based on the first base model score, the second base model score, the first probability modifier, the second probability modifier, and the third probability modifier; and
classifying the vulnerability form as valid or invalid based on the vulnerability score.

2. The computing system of claim 1, wherein determining the first base model score comprises:
identifying words in the vulnerability form that have matching keywords included in a keywords list, the keywords list further including weights of the matching keywords; and
summing the weights of the matching keywords.

3. The computing system of claim 2, wherein the operations further comprise updating the keywords list, comprising:
collecting a plurality of vulnerability forms that have been classified to be valid;
for words appearing in the plurality of vulnerability forms, determining respective word frequency and document frequency, wherein the word frequency of a selected word represents a count of the selected word appeared in the plurality of vulnerability forms, wherein the document frequency of the selected word represents a count of vulnerability forms in which the selected word appears;
calculating factors associated with the words, wherein the factor associated with the selected word represents a ratio of (i) a product of the word frequency and document frequency of the selected word, to (ii) a sum of the word frequency and document frequency of the selected word;
sorting the words based on the factors;
identifying a subset of the words with top N factors as keywords, wherein N is a predefined integer; and
assigning weights to the keywords, wherein the weight of a given keyword is determined based on a ratio of (i) the factor of the given keyword to (ii) a sum of the factors of all keywords.

4. The computing system of claim 1, wherein determining the second base model score comprises:
identifying words and phrases in the vulnerability form that are defined in a context dictionary that is specific to the vulnerability type, wherein the context dictionary assigns different context points to the words and phrases based on risk levels represented by the words and phrases for the vulnerability type; and
summing the context points associated with the words and phrases.

5. The computing system of claim 1, wherein determining the first probability modifier comprises:
identifying a first feature representing whether a word in the vulnerability form is listed in a keywords dictionary that is specific to the vulnerability type;
identifying a second feature representing whether the vulnerability form indicates a vulnerability mechanism that is specific to the vulnerability type; and
identifying a third feature representing whether the vulnerability form is associated with at least one file attachment.

6. The computing system of claim 1, wherein determining the second probability modifier comprises:
retrieving one or more screenshots from one or more file attachments associated with the vulnerability form;
extracting text from the one or more screenshots;
measuring semantic similarity between the text extracted from the one or more screenshots and text of the plurality of steps; and
identifying one or more matching steps, among the plurality of steps, that are matched to the one or more screenshots based on the measured semantic similarity.

7. The computing system of claim 6, wherein determining the second probability modifier further comprises:
evaluating a first condition to determine whether a first step and a last step, among the plurality of steps, have corresponding matching screenshots;
evaluating a second condition to determine how many intermediate steps that are between the first step and the last step have corresponding matching screenshots; and
evaluating a third condition to determine whether the one or more screenshots indicate usage of a vulnerability assessment tool for generating the vulnerability form,
wherein the second probability modifier is determined based on evaluation results of at least the first condition, the second condition, and the third condition.

8. The computing system of claim 6, wherein determining the second probability modifier further comprises:
retrieving one or more video frames from the one or more file attachments;
extracting text from the one or more video frames; and
evaluating a fourth condition to determine whether one or more predefined terms appear in the text extracted from the one or more video frames,
wherein the second probability modifier is further determined based on evaluation results of the fourth condition.

9. The computing system of claim 6, wherein determining the third probability modifier comprises:
identifying a preceding step for a given matching step that is matched to a corresponding screenshot, wherein the preceding step is not matched to any screenshot;
measuring semantic similarity between the text of the preceding step and the text of the given matching step; and
responsive to finding that the semantic similarity is greater than a predefined threshold, paring the preceding step with the given matching step, wherein the pairing causes a corresponding first increase of the third probability modifier.

10. The computing system of claim 9, wherein determining the third probability modifier further comprises:
identifying a subsequent step for the given matching step, wherein the subsequent step is not matched to any screenshot or paired with any other steps;
detecting if there is a logical connection between the given matching step and the subsequent step; and
responsive to detecting presence of the logical connection, grouping the given matching step and the subsequent step, wherein the grouping causes a corresponding second increase of the third probability modifier,
wherein the detecting comprises searching a relation dictionary containing one or more pairs of first words and second words, and determining that the logical connection exists when a first word from any pair appears in the text of the given matching step and the corresponding second word appears in the text of the subsequent step.

11. A computer-implemented method comprising:
receiving a vulnerability form submitted for a software, wherein the vulnerability form specifies a vulnerability type and a plurality of steps to reproduce a suspected bug of the software;
determining a first base model score based on keywords appeared in the vulnerability form;
determining a second base model score based on vulnerability type-specific contextual information extracted from the vulnerability form;
determining a first probability modifier based on a plurality of features identified from the vulnerability form;
determining a second probability modifier based on mapping any file attachment associated with the vulnerability form to a corresponding step among the plurality of steps;
determining a third probability modifier based on pairing and grouping selected steps among the plurality of steps;
determining a vulnerability score based on the first base model score, the second base model score, the first probability modifier, the second probability modifier, and the third probability modifier; and
classifying the vulnerability form as valid or invalid based on the vulnerability score.

12. The computer-implemented method of claim 11, wherein determining the first base model score comprises:
identifying words in the vulnerability form that have matching keywords included in a keywords list, the keywords list further including weights of the matching keywords; and
summing the weights of the matching keywords.

13. The computer-implemented method of claim 12, further comprising updating the keywords list, wherein the updating comprises:
collecting a plurality of vulnerability forms that have been classified to be valid;
for words appearing in the plurality of vulnerability forms, determining respective word frequency and document frequency, wherein the word frequency of a selected word represents a count of the selected word appeared in the plurality of vulnerability forms, wherein the document frequency of the selected word represents a count of vulnerability forms in which the selected word appears;
calculating factors associated with the words, wherein the factor associated with the selected word represents a ratio of (i) a product of the word frequency and document frequency of the selected word, to (ii) a sum of the word frequency and document frequency of the selected word;
sorting the words based on the factors;
identifying a subset of the words with top N factors as keywords, wherein N is a predefined integer; and
assigning weights to the keywords, wherein the weight of a given keyword is determined based on a ratio of (i) the factor of the given keyword to (ii) a sum of the factors of all keywords.

14. The computer-implemented method of claim 11, wherein determining the second base model score comprises:
identifying words and phrases in the vulnerability form that are defined in a context dictionary that is specific to the vulnerability type, wherein the context dictionary assigns different context points to the words and phrases based on risk levels represented by the words and phrases for the vulnerability type; and
summing the context points associated with the words and phrases.

15. The computer-implemented method of claim 11, wherein determining the first probability modifier comprises:
identifying a first feature representing whether a word in the vulnerability form is listed in a keywords dictionary that is specific to the vulnerability type;
identifying a second feature representing whether the vulnerability form indicates a vulnerability mechanism that is specific to the vulnerability type; and
identifying a third feature representing whether the vulnerability form is associated with at least one file attachment.

16. The computer-implemented method of claim 11, wherein determining the second probability modifier comprises:
retrieving one or more screenshots from one or more file attachments associated with the vulnerability form;
extracting text from the one or more screenshots;
measuring semantic similarity between the text extracted from the one or more screenshots and text of the plurality of steps; and
identifying one or more matching steps, among the plurality of steps, that are matched to the one or more screenshots based on the measured semantic similarity.

17. The computer-implemented method of claim 16, wherein determining the second probability modifier further comprises:
evaluating a first condition to determine whether a first step and a last step, among the plurality of steps, have corresponding matching screenshots;
evaluating a second condition to determine how many intermediate steps that are between the first step and the last step have corresponding matching screenshots; and
evaluating a third condition to determine whether the one or more screenshots indicate usage of a vulnerability assessment tool for generating the vulnerability form,
wherein the second probability modifier is determined based on evaluation results of at least the first condition, the second condition, and the third condition.

18. The computer-implemented method of claim 16, wherein determining the third probability modifier comprises:
identifying a preceding step for a given matching step that is matched to a corresponding screenshot, wherein the preceding step is not matched to any screenshot;
measuring semantic similarity between the text of the preceding step and the text of the given matching step; and
responsive to finding that the semantic similarity is greater than a predefined threshold, paring the preceding step with the given matching step, wherein the pairing causes a corresponding first increase of the third probability modifier.

19. The computer-implemented method of claim 18, wherein determining the third probability modifier further comprises:
identifying a subsequent step for the given matching step, wherein the subsequent step is not matched to any screenshot or paired with any other steps;
detecting if there is a logical connection between the given matching step and the subsequent step; and
responsive to detecting presence of the logical connection, grouping the given matching step and the subsequent step, wherein the grouping causes a corresponding second increase of the third probability modifier,
wherein the detecting comprises searching a relation dictionary containing one or more pairs of first words and second words, and determining that the logical connection exists when a first word from any pair appears in the text of the given matching step and the corresponding second word appears in the text of the subsequent step.

20. One or more non-transitory computer-readable media having encoded thereon computer-executable instructions causing one or more processors to perform a method, the method comprising:
receiving a vulnerability form submitted for a software, wherein the vulnerability form specifies a vulnerability type and a plurality of steps to reproduce a suspected bug of the software;
determining a first base model score based on keywords appeared in the vulnerability form;
determining a second base model score based on vulnerability type-specific contextual information extracted from the vulnerability form;
determining a first probability modifier based on a plurality of features identified from the vulnerability form;
determining a second probability modifier based on mapping any file attachment associated with the vulnerability form to a corresponding step among the plurality of steps;
determining a third probability modifier based on pairing and grouping selected steps among the plurality of steps;
determining a vulnerability score based on the first base model score, the second base model score, the first probability modifier, the second probability modifier, and the third probability modifier; and
classifying the vulnerability form as valid or invalid based on the vulnerability score.
